(19) United States
(12) Patent Application Publication
(10) Pub. No.: US 2008/0122359 A1
(43) Pub. Date: May 29, 2008

(54) Plasma display panel

(76) Inventor: Jung-Suk Song, Suwon-si (KR)

Correspondence Address: Robert E. Bushnell;Suite 300, 1522 K Street, N.W., Washington, DC, 20005-1202, US

(21) Appl. No.: 11/826,194

(22) Filed: Jul. 12, 2007

(30) Foreign Application Priority Data
Nov. 27, 2006 (KR) 10-2006-0117848

(51) Int. Cl. H01J 17/49

(52) U.S. Cl. 313/584

(57) ABSTRACT

A plasma display panel comprises: a first substrate; a second substrate facing the first substrate; barriers forming discharge cells by partitioning a space between the first and second substrates; address electrodes formed so as to correspond to the discharge cells; display electrodes formed so as to cross the address electrodes in the discharge cells; and fluorescent layers formed in the discharge cells. The address electrodes include first address electrodes having a first width and second address electrodes having a second width wider than the first width. When a region where the discharge cells are formed is divided into three parts in a direction crossing an extending direction of the address electrodes, the second address electrodes are formed in a center region, and the first address electrodes are formed in remaining regions excluding the center region.

### CLAIM OF PRIORITY

This application makes reference to, incorporates the same herein, and claims all benefits accruing under 35 U.S.C. § 119 from an application for PLASMA DISPLAY PANEL earlier filed in the Korean Intellectual Property Office on the 27 of Nov. 2006 and there duly assigned Serial No. 10-2006-0117848.

### BACKGROUND. OF THE INVENTION

1. Technical Field

The present invention relates to a plasma display panel for improving image display performance.

2. Related Art

A plasma display panel (PDP) is a display device for implementing an image by using visible light which is generated when ultraviolet (UV) light emitted from plasma formed by gas discharge excites a fluorescent layer. The PDP can be constructed to have a large screen with a high resolution, and thus the PDP has been proposed as a next-generation flat panel display.

The general structure of the PDP is a three-electrode surface-discharge structure. In this structure, pairs of electrodes are formed on a front substrate and the electrodes face the surface, and an address electrode is disposed on a rear substrate. The electrodes are formed so as to correspond to each discharge cell.

Inside the PDP, hundreds or more unit discharge cells are arrayed in a matrix form. The discharge cells are formed by barriers which are disposed between the two substrates, and which partition a space between the two substrates. The discharge cells form sub-pixels which are the smallest units for displaying images. Therefore, it is important to form the discharge cells in a uniform size at all positions.

However, as the size of the PDP increases, it becomes more difficult to form the discharge cells in a uniform size. For example, when the barriers are formed by performing a sandblasting process, side portions of the PDP are easily etched. Furthermore, the center portion thereof is not easily etched as compared with the side portions. Therefore, sizes of the discharge cells in the center portion of the PDP become different from those in the side portions thereof. This problem also occurs when the barriers are formed by performing a photoresist process.

When sizes of the discharge cells are different according to positions as described above, the amount of florescent material formed in the discharge cells becomes different. Consequently, light emitting luminance of the discharge cells may not be uniform according to position.

### SUMMARY OF THE INVENTION

The present invention provides a plasma display panel for reducing the differences of light emitting luminance of discharge cells with different sizes.

According to an aspect of the present invention, a plasma display panel comprises: a first substrate; a second substrate facing the first substrate; barriers forming discharge cells by partitioning a space between the first and second substrates; address electrodes formed so as to correspond to the discharge cells; display electrodes formed so as to cross the address electrodes in the discharge cells; and fluorescent layers formed in the discharge cells. The address electrodes include first address electrodes having a first width and second address electrodes having a second width wider than the first width, and when a region where the discharge cells are formed is divided into three parts in a direction crossing an extending direction of the address electrodes, the second address electrodes are formed in the center region and the first address electrodes are formed in the remaining region excluding the center region.

In the above aspect of the present invention, the width of a second address electrode may be larger than the width of a first address electrode, and it may be up to 1.5 times the width of the first address electrode. In addition, the second address electrode may have a maximum width of 150 μm.

Furthermore, the discharge cells formed in the center region may be smaller than the discharge cells formed in the remaining region.

According to another aspect of the present invention, a plasma display panel comprises: a first substrate; a second substrate facing the first substrate; barriers forming a plurality of discharge cells by partitioning a space between the first and second substrates; address electrodes formed so as to correspond to the discharge cells; display electrodes formed so as to cross the address electrodes in the discharge cells; and fluorescent layers formed in the discharge cells. When a region where the discharge cells are formed is divided into a first region formed in the center region of the panel and a second region formed so as to surround the first region, the width of an address electrode formed in the first region is larger than that of an address electrode formed in the second region.

In the above aspect of the present invention, the width of the address electrode in the first region may be larger than the width of the address electrode in the second region, and it may be up to 1.5 times the width of the address electrode in the second region. In addition, the address electrode in the first region may have a maximum width of 150 μm.

Furthermore, the discharge cells formed in the first region may be smaller than those in the second region.

According to another aspect of the present invention, a plasma display panel comprises: a first substrate; a second substrate facing the first substrate; barriers forming discharge cells by partitioning a space between the first and second substrates; address electrodes extending along the discharge cells in a first direction; first and second electrodes extending in a second direction crossing the address electrodes in the discharge cells, and facing each other in the discharge cells so as to form a discharge gap; and fluorescent layers formed in the discharge cells. The first and second electrodes include bus electrodes and protrusion electrodes protruding from the bus electrodes so as to form the discharge gap, and when a region where the discharge cells are formed is divided into three parts comprising the center region and the remaining regions adjacent to the center region, the protrusion electrodes formed in the center region are larger than those in the remaining regions.

In the above aspect of the present invention, the protrusion electrodes may have a first width in the center region and a second width smaller than the first width in the remaining regions based on the second direction.

The discharge gap in the remaining region may be larger than that in the center region.

In addition, the discharge cells formed in the center region may be smaller than those in the remaining region.

In this case, the address electrodes may include first address electrodes having a third width and second address electrodes having a fourth width larger than the third width. The first address electrodes may be formed in the remaining regions, and the second address electrodes may be formed in the center region.

According to another aspect of the present invention, a plasma display panel comprises: a first substrate; a second substrate facing the first substrate; barriers forming discharge cells by partitioning a space between the first and second substrates; address electrodes extending along the discharge cells in a first direction; first and second electrodes extending in a second direction crossing the address electrodes in the discharge cells, and facing each other in the discharge cells so as to form a discharge gap; and fluorescent layers formed in the discharge cells. The first and second electrodes include bus electrodes and protrusion electrodes protruding from the bus electrodes so as to form the discharge gap, and when a region where the discharge cells are formed is divided into a first region formed in the center region of the panel and a second region formed to surround the first region, the protrusion electrodes formed in the first region are larger than those in the second region.

In the above aspect of the present invention, the protrusion electrodes may have a first width in the first region and a second width in the second region smaller than the first width based on the second direction.

The discharge gap in the first region may be wider than that in the second region.

In addition, the discharge cells in the first region may be smaller than those in the second region.

In this case, the width of the address electrodes in the first region may be larger than that in the second region.

A plasma display panel with a resolution of more than 1024×768 may be applied to the plasma display panel in the embodiments of the present invention.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a top plan view showing a plasma display panel according to a first embodiment of the present invention;

FIG. 2 is a perspective view showing an enlarged portion A of FIG. 1;

FIG. 3 is a graph showing the result of an experiment for measuring light emitting luminance with a changing width of an address electrode;

FIG. 4 is a top plan view showing an arrangement of discharge cells and address electrodes of a plasma display panel according to the first embodiment of the present invention;

FIG. 5 is a top plan view of a plasma display panel according to a second embodiment of the present invention;

FIG. 6 is a top plan view showing an arrangement of discharge cells and address electrodes of a plasma display panel according to the second embodiment of the present invention;

FIG. 7 is a top plan view showing an arrangement of discharge cells and display electrodes of a plasma display panel according to a third embodiment of the present invention; and

FIG. 8 is a top plan view showing an arrangement of discharge cells and display electrodes of a plasma display panel according to a fourth embodiment of the present invention.

### DETAILED DESCRIPTION OF THE EMBODIMENTS

The present invention will be described more fully hereinafter with reference to the accompanying drawings, in which preferred embodiments of the invention are shown. As those skilled in the art will realize, the described embodiments may be modified in various different ways, all without departing from the spirit or scope of the present invention.

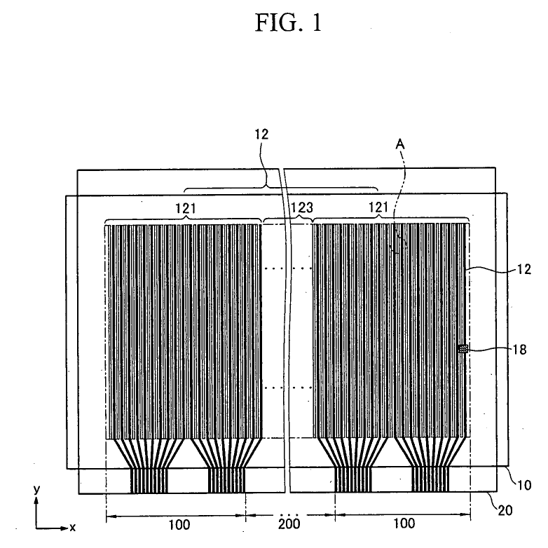

FIG. 1 is a top plan view showing a plasma display panel according to a first embodiment of the present invention.

Referring to FIG. 1, the plasma display panel (PDP) according to this embodiment includes a front substrate 20 and a rear substrate 10 which face each other with a predetermined gap therebetween.

In addition, barriers (not shown) are disposed in the space between the front substrate 20 and the rear substrates 10, and they partition the space to form discharge cells 18.

A plurality of the discharge cells 18 is formed in the space between the front and rear substrate 20 and 10, respectively, so as to construct sub-pixels which are the smallest units for displaying images.

In correspondence to the discharge cells 18, address electrodes 12 are formed. The address electrodes 12 select a discharge cell which is turned on from among the discharge cells 18. In FIG. 1, the case wherein the address electrodes 12 extend in a first direction (the y-axis direction in the figure) is exemplified.

In addition, when a region wherein the discharge cells 18 are formed is divided into three parts in a second direction (x-axis direction in FIG. 1) crossing the first direction, the address electrodes 12 include second address electrodes 123 having a second width in a center region 200 and first address electrodes 121 having a first width narrower than the second width in a remaining region 100.

According to the current embodiment, in the center region 200, that is, in the discharge cells with a small size and relatively low light emitting luminance, the address electrodes 123 are formed so as to have a larger width, so that the magnitude of discharge increases and the light emitting luminance also increases.

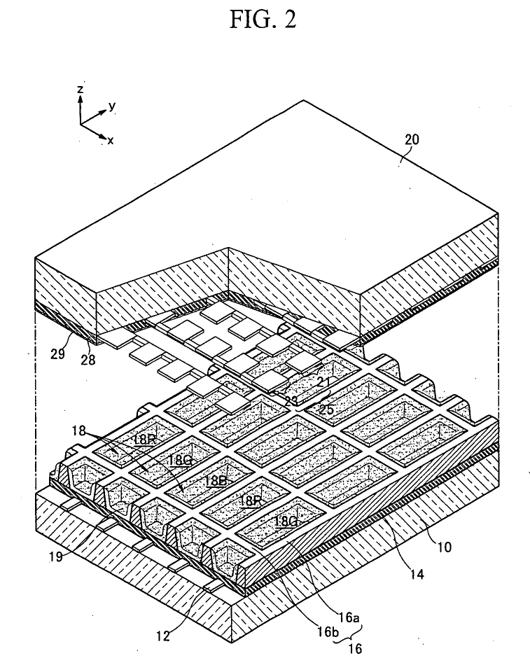

Construction of the discharge cells 18 will be described in detail with reference to FIG. 2, which is a perspective view showing an enlarged portion A of FIG. 1.

In FIG. 2, the PDP according to the current embodiment includes the front substrate 20 and the rear substrate 10 which face each other. The space between the substrates 20 and 10 is partitioned by the barriers 16 so as to form the discharge cells 18.

A display electrode 25 and an address electrode 12 are formed so as to correspond to each discharge cell 18. The display electrodes 25 and the address electrodes 12 are spaced apart from one another and extend in directions so as to cross each other, and each discharge cell 18 is disposed at a position where a display electrode 25 and an address electrode 12 cross.

The display electrodes 25 are formed on the front substrate 20, and each display electrode 25 may include a first electrode (hereinafter referred to as a scan electrode) 21 and a second electrode (hereinafter referred to as a sustain electrode) 23. In this case, the scan electrode 21 is operated with the address electrode 12 in order to select a discharge cell which is turned on, and the sustain electrode 23 is operated with the scan electrode 21 in order to discharge the selected discharge cell.

Furthermore, in this case, the scan electrode 21 and the sustain electrode 23 two-dimensionally face each other in the discharge cell 18 so as to form a discharge gap therebetween.

The display electrode 25 is buried and protected by a dielectric layer 28 made of a dielectric material (for example, PbO, B₂O₃, or SiO₂). The dielectric layer 28 prevents the display electrode 25 from being damaged by impact of charged particles during discharge. The dielectric layer 28 may be covered with a protection layer 29 (formed, for example, of MgO).

The address electrodes 12 may be formed on the rear substrate 10 facing the front substrate 20. As shown in FIG. 2, each address electrode 12 crosses a display electrode 25, extends in a direction (y-axis direction in the figure) so as to correspond to each discharge cell 18, and is parallel to an adjacent address electrode 12.

The address electrodes 12 are buried and protected by a dielectric layer 14, and on the dielectric layer 14, the barriers 16 (including first barrier members 16a extending in the first direction and second barrier members 16b extending in the second direction) are arranged so as to form the discharge cells 18.

The barriers 16 in the remaining region 100 (FIG. 1) are more easily etched than the barriers 16 in the center region 200, so that the sizes of the discharge cells partitioned by the barriers 16 in the remaining region 100 are larger than those in the center region 200.

A fluorescent material is coated on the sidewalls and on the bottom of each discharge cell 18, so that a fluorescent layer 19 (FIG. 2) emitting visible light of each color is formed in the discharge cell 18. In this case, since the size of the discharge cell 18 in the center region 200 (FIG. 1) is smaller than that of the discharge cell 18 in the remaining region 100, the amount of fluorescent material coated on the discharge cell 18 in the center region 200 is smaller than that in the remaining region 100.

A fluorescent layer 19 (FIG. 2) having a color of red (R), green (G), or blue (B) is formed in a respective discharge cell in order to display an image, and a red discharge cell 18R, a green discharge cell 18G, and a blue discharge cell 18B as a group constitute a pixel.

The inside of the discharge cell 18 on which the fluorescent layer 19 is formed is filled with a discharge gas such as a mixture of neon (Ne) and xenon (Xe).

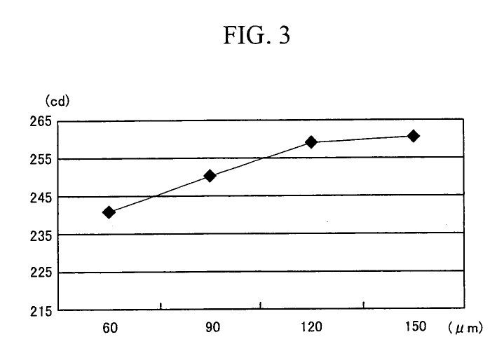

FIG. 3 is a graph showing the result of an experiment for measuring light emitting luminance while changing a width of the address electrode. The experiment was performed with a 42 inch PDP SD TV.

As shown in the graph, when the width of the address electrode is 60 μm, the light emitting luminance is 240 cd. As the width of the address electrode increases to 90 μm and 120 μm, the light emitting luminance also increases to 250 cd and 260 cd, respectively.

As a result, it can be seen that, as the width of the address electrode increases, the light emitting luminance also increases linearly.

However, when the width of the address electrode is more than 120 μm, the gradient becomes gentle. When the width is more than 150 μm, there is little change in the light emitting luminance. As described above, when the width of an address electrode is more than a predetermined size, the width of the address electrode does not influence the light emitting luminance.

Considering the result, in the current embodiment, since the address electrodes 12 (FIG. 1) include the first address electrodes 121 formed in the remaining regions 100 and the second address electrodes 123 formed in the center region 200, the width of a second address electrode 123 is larger than that of a first address electrode 121.

Referring to the result of the experiment, the width of the second address electrode 123 may be wider than the first address electrode 121, and it may be up to 1.5 times the width of the first address electrode 121. In addition, with the aforementioned result of the experiment, considering the size of the discharge cell, the second address electrode 123 has a maximum size of 150 μm.

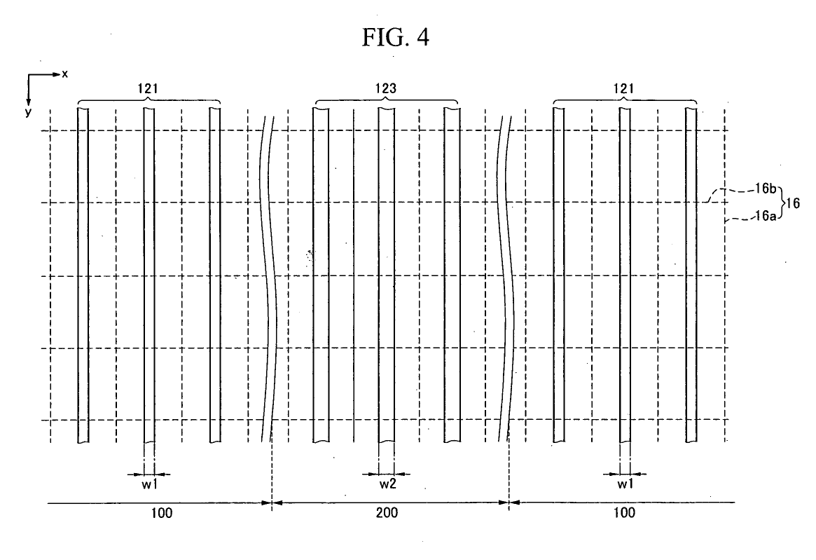

FIG. 4 is a top plan view showing an arrangement of discharge cells and address electrodes of a plasma display panel according to the first embodiment of the present invention.

In FIG. 2 and FIG. 4, the barriers 16 disposed between the front and rear substrates 20 and 10, respectively, partition the space between the substrates 20 and 10 so as to form the discharge cells 18.

When a region where the discharge cells 18 are formed is divided into three parts in the second (x-axis) direction, the second address electrodes 123 having a second width w2 are formed in the center region 200, and the first address electrodes 121 having a first width w1 narrower than the second width w2 are formed in the remaining regions 100.

In this respect, the widths of the first and second address electrodes 121 and 123, respectively, are related to each other. As described above, the second width w2 is larger than the first width w1, and is up to 1.5 times the first width w1. The second width w2 has a maximum size of 150 μm.

Each first address electrode 121 and each second address electrode 123 are formed so as to correspond to a discharge cell formed in a row in the first (y-axis) direction. As a result, the first and second address electrodes 121 and 123, respectively, extend in the first direction and form a stripe pattern.

As stated, the second address electrodes 123 are formed in the center region 200 of the panel and the first address electrodes 121 are formed in the remaining or side regions 100 of the panel.

In this case, since each second address electrode 123 has the second width w2 wider than that of each first address electrode 121, as described above with reference to FIG. 3, the problem of a luminance difference of the panel caused by the discharge cells disposed in the center region 200 having a low light emitting luminance for structural reasons can be solved.

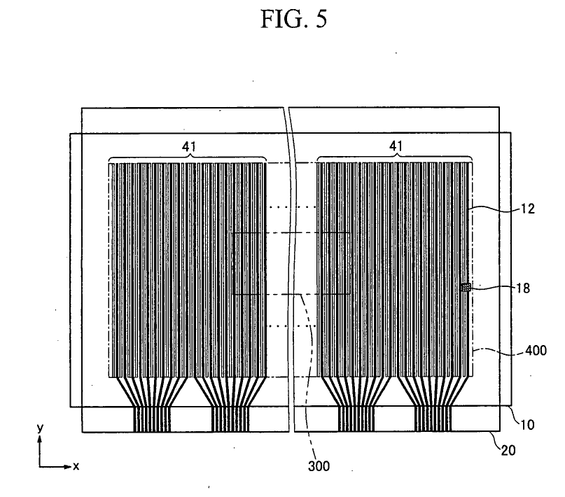

Hereinafter, a PDP according to a second embodiment of the present invention will be described with reference to FIG. 5, which is a top plan view of a PDP according to the second embodiment of the present invention. Like reference numerals designate like elements throughout the specification.

In FIG. 5, the PDP according to the second embodiment includes a front substrate 20 and a rear substrate 10 which face each other with a predetermined gap therebetween, and barriers (not shown) disposed in a space between the substrates 20 and 10 partition the space to form discharge cells 18.

Address electrodes 41 are formed so as to correspond to the discharge cells 18. Each address electrode 41 selects a discharge cell which is turned on from among a plurality of the discharge cells 18. In FIG. 5, a case wherein the address electrodes 41 extend in the first (y-axis) direction is exemplified.

When a region wherein the discharge cells 18 are formed is divided into a first region 300 formed in the center region of the panel and a second region 400 formed so as to surround the first region 300, the widths of the address electrodes 41 in the first region 300 are larger than those in the second region 400.

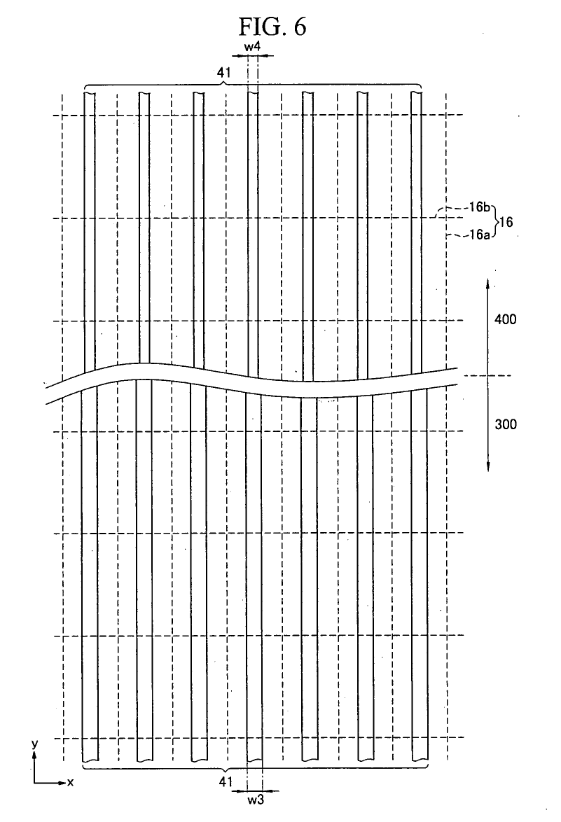

This will be described in detail with reference to FIG. 6, which is a top plan view showing an arrangement of discharge cells and address electrodes of the PDP according to the second embodiment of the present invention.

In FIGS. 2, 5 and 6, as described above, the space between the front and rear substrates 20 and 10, respectively, is partitioned by the barriers 16 to form the discharge cells 18.

In this case, the barriers 16 in the second region 400 (FIG. 5) are more easily etched than those in the first region 300, so that the sizes of the discharge cells formed by the barriers 16 in the second region 400 are larger than those in the first region 300.

According to positions, the address electrodes 41 (FIG. 6) have a third width w3 in the first region 300 and have a fourth width w4 in the second region 400.

Here, the third and fourth widths w3 and w4 are related to each other. With reference to FIG. 6, the third width w3 is larger than the fourth width w4 and is up to 1.5 times the fourth width w4. The third width w3 has a maximum size of 150 μm.

Each address electrode 41 is formed so as to correspond to a discharge cell formed in a row in the first (y-axis) direction. As a result, the address electrodes 41 extend in the first direction and form a stripe pattern.

Therefore, the address electrodes 41 are formed so as to have the third width w3 in the first region 300 and the fourth width w4 in the second region 400.

As described above, since the width of the address electrode formed to correspond to the first region 300 having low light emitting luminance of the discharge cells is larger than that in the second region 400, address discharge can more easily occur in the first region 300 than in the second region 400. Therefore, the problem of a luminance difference of the PDP caused by the discharge cells disposed in the first region 300 having low light emitting luminance due to structural reasons can be solved.

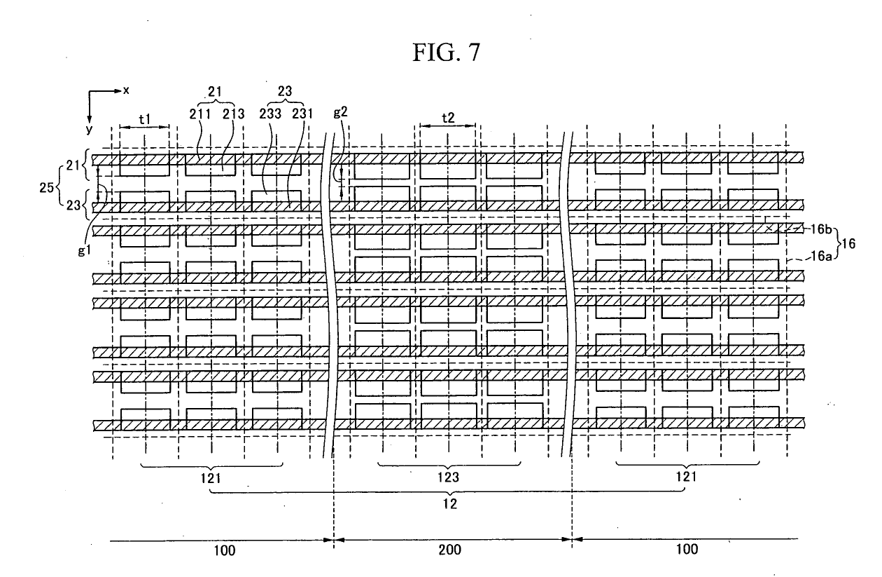

Hereinafter, a plasma display panel according to a third embodiment of the present invention will be described in detail with reference to FIG. 7, which is a top plan view showing an arrangement of discharge cells and display electrodes of a PDP according to a third embodiment of the present invention. Like reference numerals designate like elements throughout the specification.

In the third embodiment, the barriers 16 include first barrier members 16a extending in the first direction (y-axis in the figure) and second barrier members 16b extending in the second direction (x-axis in the figure) crossing the first direction. Accordingly, the discharge cells 18 are formed in a matrix array.

When the region where the discharge cells 18 are formed is divided into three parts in the second (x-axis) direction, the discharge cells 18 in the center region 200 are smaller than those in the remaining regions 100.

Each display electrode 25 includes a scan electrode 21 and a sustain electrode 23 which face each other in the discharge cell 18.

Each scan electrode 21 and each sustain electrode 23 includes bus electrodes 211 and 231, respectively, extending in the second (x-axis) direction, and protrusion electrodes 213 and 233, respectively, protruding from the bus electrodes 211 and 231, respectively, toward the inside of a discharge cell 18. The protrusion electrodes 213 and 233 face each other in the discharge cell to form a discharge gap g1 or g2 therebetween. Here, the first discharge gap g1 formed in the remaining regions 100 is wider than the second discharge gap g2 formed in the center region 200.

The bus electrodes 211 and 231 are made of metal (for example copper, silver, chromium, or the like), and the protrusion electrodes 213 and 233 are made of a transparent nonmetal (for example, indium tin oxide (ITO)).

In addition, when the protrusion electrodes 213 and 233 formed in the center region 200 and the remaining regions 100 are compared to each other, a width t2 of each protrusion electrode 213 and 233 formed in the center region 200 is larger than a width t1 of each protrusion electrode 213 and 233 formed in the remaining regions 100.

Accordingly, since a portion where the electrodes face each other in the center region 200 is wider than that in the remaining regions 100, the magnitude of discharge in the center region 200 is larger than that in the remaining regions 100. Consequently, although the discharge cells in the remaining regions 100 are larger than those in the center region 200, the discharge magnitude in the remaining regions 100 is relatively small, so that a light emitting luminance difference according to size can be reduced.

Address electrodes 12 extend in the first (y-axis) direction so as to cross the display electrodes 25. Similar to those in the aforementioned first embodiment, the address electrodes 12 include first address electrodes 121 having a first width w1 and second address electrodes 123 having a second width wider than the first width w1. In this regard, the first address electrodes 121 are formed in the remaining regions 100, and the second address electrodes 123 are formed in the center region 200.

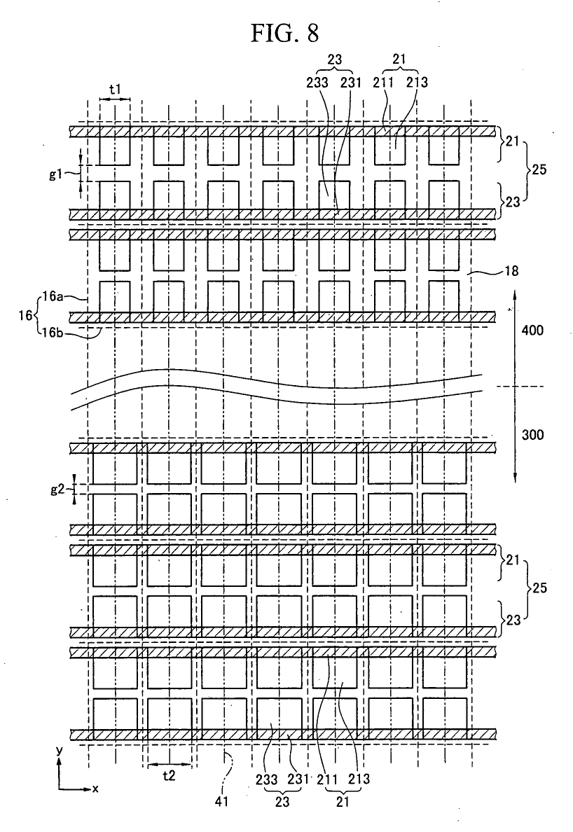

Hereinafter, a plasma display panel according to a fourth embodiment of the present invention will be described in detail with reference to FIG. 8, which is a top plan view showing an arrangement of discharge cells and display electrodes of a plasma display panel according to a fourth embodiment of the present invention. Like reference numerals designate like elements throughout the specification.

In FIG. 8, the discharge cells 18 are formed by first barrier members 16a and second barrier members 16b in a matrix array. When a region where the discharge cells 18 are divided into a first region 300 formed in the center region of the panel and a second region 400 formed so as to surround the first region 300, the discharge cells 18 formed in the first region 300 are smaller than the discharge cells 18 in the second region 400.

The display electrodes 25 extend in the second (x-axis) direction. In this respect, each display electrode 25 includes a scan electrode 21 and a sustain electrode 23 which face each other in the discharge cell 18.

Each scan electrode 21 and each sustain electrode 23 includes bus electrodes 211 and 231, respectively, extending in the second direction, and protrusion electrodes 213 and 233, respectively, protruding from the bus electrodes 211 and 231, respectively, toward the inside of the discharge cell 18. The discharge electrodes 213 and 233 face into the discharge cell 18 so as to form a discharge gap g1 or g2. Here, the first discharge gap g1 formed in the second region 400 is wider than the second discharge gap g2 formed in the first region 300.

The bus electrodes 211 and 231 are made of metal (for example copper, silver, chromium, or the like), and the protrusion electrodes 213 and 233 are made of a transparent nonmetal (for example, ITO).

In addition, when the protrusion electrodes 213 and 233 formed in the first and second regions 300 and 400 are compared to each other, a width t2 of each protrusion electrode 213 and 233 formed in the first region 300 is larger than a width t1 of each protrusion electrode 213 and 233 formed in the second region 400.

Accordingly, since a portion where the electrodes face each other in the first region 300 is wider than that in the second region 400, the magnitude of discharge in the first region 300 is larger than that in the second region 400. Consequently, although the discharge cells in the second region 400 are larger than those in the first regions 300, the discharge magnitude is relatively small, so that a light emitting luminance difference according to size can be reduced.

Address electrodes 41 extend in the first (y-axis) direction crossing the display electrodes 25. In this regard, the address electrodes 41 have the third width w3 in the first region 300 as in the aforementioned second embodiment, and have the fourth width w4, narrower than the third width w3, in the second region 400.

According to the aforementioned embodiments, the width of an address electrode corresponding to a small discharge cell is large, and the width of an address electrode corresponding to a large discharge cell is small, so that address discharge can more easily occur in the small discharge cell. As a result, during sustain discharge after the address discharge, the discharge magnitude in the small discharge cell is increased, so that the problem of a luminance difference according to size of the discharge cell can be solved.

In addition, according to the aforementioned embodiments, a portion where the protrusion electrodes corresponding to the small discharge cell face is wide, and a portion where the protrusion electrodes corresponding to the large discharge cell face is narrow, so that discharge can more easily occur in the small discharge cell. As a result, although a discharge cell is small, the magnitude of discharge can be controlled, so that the problem of a light emitting difference according to size of a discharge cell can be solved.

Therefore, even though the plasma display panel is constructed to have a large screen, the problem of light emitting luminance difference according to size of the discharge cell caused by problems in the manufacturing processes can be solved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display panel, comprising:
a first substrate;
a second substrate facing the first substrate;
barriers forming discharge cells by partitioning a space between the first and second substrates;
address electrodes formed so as to correspond to the discharge cells;
display electrodes formed so as to cross the address electrodes in the discharge cells; and
fluorescent layers formed in the discharge cells;
wherein the address electrodes comprise first address electrodes having a first width and second address electrodes having a second width larger than the first width; and
wherein, when a region where the discharge cells are formed is divided into three parts in a direction crossing an extending direction of the address electrodes, the second address electrodes are formed in the center region, and the first address electrodes are formed in remaining regions excluding the center region.

2. The plasma display panel of claim 1, wherein the second width of each second address electrode is larger than the first width of each first address electrode, and is up to 1.5 times the width of said each first address electrode.

3. The plasma display panel of claim 2, wherein said each second address electrode has a maximum width of 150 μm.

4. The plasma display panel of claim 1, wherein the first and second address electrodes are formed in a stripe pattern in a direction crossing an extending direction of the display electrodes.

5. The plasma display panel of claim 1, wherein the discharge cells formed in the center region are smaller than the discharge cells formed in the remaining regions.

6. A plasma display panel, comprising:
a first substrate;
a second substrate facing the first substrate;
barriers forming a plurality of discharge cells by partitioning a space between the first and second substrates;
address electrodes formed so as to correspond to the discharge cells;
display electrodes formed so as to cross the address electrodes in the discharge cells; and
fluorescent layers formed in the discharge cells;
wherein, when a region where the discharge cells are formed is divided into a first region formed in a center region of the plasma display panel and a second region formed so as to surround the first region, a width of each address electrode formed in the first region is larger than a width of each address electrode formed in the second region.

7. The plasma display panel of claim 6, wherein the width of said each address electrode in the first region is larger than the width of said each address electrode in the second region, and is up to 1.5 times the width of said each address electrode in the second region.

8. The plasma display panel of claim 7, wherein said each address electrode in the first region has a maximum width of 150 μm.

9. The plasma display panel of claim 6, wherein the address electrodes are formed in a stripe pattern in a direction crossing an extending direction of the display electrodes.

10. The plasma display panel of claims 6, wherein the discharge cells formed in the first region are smaller than the discharge cells formed in the second region.

11. A plasma display panel, comprising:
a first substrate;
a second substrate facing the first substrate;
barriers forming discharge cells by partitioning a space between the first and second substrates;
address electrodes extending along the discharge cells in a first direction;
first and second electrodes extending in a second direction crossing the address electrodes in the discharge cells, and facing each other in the discharge cells so as to form a discharge gap; and
fluorescent layers formed in the discharge cells;
wherein each of the first and second electrodes comprises a bus electrode and a protrusion electrode protruding from the bus electrode to form the discharge gap; and
wherein, when a region where the discharge cells are formed is divided into three parts including a center region and remaining regions adjacent to the center region, the protrusion electrodes formed in the center region are larger than the protrusion electrodes formed in the remaining regions.

12. The plasma display panel of claim 11, wherein the protrusion electrodes have a first width in the center region and have a second width, smaller than the first width, in the remaining regions based on the second direction.

13. The plasma display panel of claim 11, wherein the discharge gap in the remaining regions is larger than the discharge gap in the center region.

14. The plasma display panel of claim 11, wherein the discharge cells formed in the center region are smaller than the discharge cells in the remaining regions.

15. The plasma display panel of claim 11,
wherein the address electrodes comprise first address electrodes, each having a third width, and second address electrodes, each having a fourth width larger than the third width; and
wherein the first address electrodes are formed in the remaining regions, and the second address electrodes are formed in the center region.

16. The plasma display panel of claim 15, wherein the fourth width of each second address electrode is up to 1.5 times the third width of each first address electrode.

17. The plasma display panel of claim 16, wherein said each second address electrode has a maximum width of 150 μm.

18. A plasma display panel, comprising:
a first substrate;
a second substrate facing the first substrate;
barriers forming discharge cells by partitioning a space between the first and second substrates;
address electrodes extending along the discharge cells in a first direction;
first and second electrodes extending in a second direction crossing the address electrodes in the discharge cells, and facing each other in the discharge cells so as to form a discharge gap; and
fluorescent layers formed in the discharge cells;
wherein each of the first and second electrodes comprises a bus electrode and a protrusion electrode protruding from the bus electrodes to form the discharge gap; and
wherein, when a region where the discharge cells are formed is divided into a first region comprising a center region of the plasma display panel and a second region formed so as to surround the first region, each protrusion electrode formed in the first region is larger than each protrusion electrode formed in the second region.

19. The plasma display panel of claim 18, wherein said each protrusion electrode in the first region has a first width and said each protrusion electrode in the second region has a second width smaller than the first width based on the second direction.

20. The plasma display panel of claim 18, wherein the discharge gap in the first region is wider than the discharge gap in the second region.

21. The plasma display panel of claim 18, wherein the discharge cells in the first region are smaller than the discharge cells in the second region.

22. The plasma display panel of claim 18, wherein a width of each address electrode in the first region is larger than a width of each address electrode in the second region.

23. The plasma display panel of claim 22, wherein the width of said each address electrode in the first region is up to 1.5 times the width of said each address electrode in the second region.

24. The plasma display panel of claim 23, wherein said each address electrode in the first region has a maximum width of 150 μm.
